(19) United States
(12) Patent Application Publication
(10) Pub. No.: US 2008/0177527 A1
(43) Pub. Date: Jul. 24, 2008

(54) Simulation system, simulation method and simulation program

(75) Inventor: Megumi Yoshinaga, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC ELECTRONICS CORPORATION, Kawasaki (JP)

(21) Appl. No.: 12/007,437

(22) Filed: Jan. 10, 2008

(30) Foreign Application Priority Data
Jan. 17, 2007 (JP) 7888/2007

(51) Int. Cl. G06F 9/455

(52) U.S. Cl. 703/26

(57) ABSTRACT

Disclosed is a simulation system including an instruction processor, a simultaneous execution condition determination unit and an execution machine cycle correction unit. The instruction processor executes each of instructions included in an analysis target program. The simultaneous execution condition determination unit divides the instructions into execution instruction sets, at least one of the execution instruction sets including a plurality of the instructions which are executable simultaneously. The execution machine cycle correction unit corrects the number of execution machine cycles of the instructions included in the at least one of the execution instruction sets to produce corrected information. In response to the corrected information, a simulation result including a processing time for execution of the analysis target program is outputted.

### BACKGROUND OF THE INVENTION

1. Field of the Invention

The present invention relates to a simulation system, a simulation method and a simulation program for simulating an operation of a processor.

2. Description of Related Art

A simulation system has been used for analyzing or debugging a program to be executed by a processor. Such a simulation system is designed to perform the same operation as, or a simpler operation than, the processor. As an example of such a simulation system, an instruction set simulator (hereinafter, referred to as an ISS) is widely known. An ISS operates on a computer such as a personal computer or a workstation and simulates processor's operations to deal with instructions, their execution results, a register's working status during the operations for the instructions, and the like. Using an ISS provides a benefit of eliminating the necessity to prepare dedicated hardware for analyzing or debugging a program.

In a program analysis by use of an ISS or the like, it is beneficial if information indicating an execution speed of the program can be obtained in addition to information indicating the validity of the operation of the program. To be more specific, the information indicating an execution speed of the program means information on how many cycles are required for a processor to process an instruction in the program. Japanese Patent Application Laid-open Publication No. 2001-290857, for example, discloses a technique related to a simulation method for performing an operation that is equivalent to an operation performed by hardware including a pipeline mechanism. In this technique, information on the state of a pipeline during the execution of each instruction is obtained with reference to a timing table for each instruction, and thereby, the number of execution machine cycles taking the pipeline into consideration is calculated.

We have now discovered that processors that have been developed in recent years tend to have a plurality of pipelines in a single processor in order to increase the processing speed of an instruction. Accordingly, it is desirable that a simulation technique taking a plurality of pipelines into consideration be used for developing a program to be operated on such a processor.

In Japanese Patent Application Laid-open Publication No. 2001-290857, however, a technique for simulating an operation of a processor including a plurality of pipelines is not described at all. In a case where this conventional technology is applied to a processor including a plurality of pipelines, it is difficult to calculate the numbers of machine cycles of the entire processor, which operates in combination of the plurality of pipelines, although the numbers of machine cycles executed by an individual pipeline may be calculated.

### SUMMARY

The present invention seeks to solve one or more of the above problems, or to improve upon those problems at least in part.

In one embodiment, a simulation system for simulating an operation of a processor including a plurality of pipeline mechanisms comprises an instruction processor which executes each of instructions included in an analysis target program formed of an instruction set executable by the processor, a simultaneous execution condition determination unit which divides the instructions into execution instruction sets, at least one of the execution instruction sets including a plurality of the instructions which are executable simultaneously, an execution machine cycle correction unit which corrects the number of execution machine cycles of the instructions included in the at least one of the execution instruction sets to produce corrected information and a number-of-execution-machine-cycle measurement unit which outputs a simulation result including a processing time for execution of the analysis target program in response to the corrected information.

According to the simulation system of the present invention, the number of the execution machine cycles can be generated in consideration for the instructions which are executable simultaneously when an operation of the processor is simulated.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a diagram showing a configuration of a simulation system 4 of the present invention (first and second embodiments).

FIG. 2 is a diagram showing a configuration of a computer (first and second embodiments).

FIG. 3 is a schematic diagram of a pipeline portion of a processor 70, the operation of which is to be simulated by use of the present invention.

FIG. 4 is a diagram showing a configuration of a simulation engine unit 7 (first embodiment).

FIG. 5 is a diagram showing a simultaneous execution condition storage unit 32 (first and second embodiments).

FIG. 6 is a diagram showing a number-of-execution-cycle storage unit 42 (first and second embodiments).

FIG. 7A is a diagram provided for describing an operation of the simulation system 4 of the present invention (the first embodiment).

FIG. 7B is another diagram provided for describing an operation of the simulation system 4 of the present invention (the first embodiment).

FIG. 8A is yet another diagram provided for describing an operation of the simulation system 4 of the present invention (the first embodiment).

FIG. 8B is still another diagram provided for describing an operation of the simulation system 4 of the present invention (the first embodiment).

FIG. 9 is a diagram showing an execution result 60 (the first embodiment).

FIG. 10 is a flowchart showing an operation of the simulation engine unit 7 (the first embodiment).

FIG. 11 is a diagram showing a configuration of a simulation engine unit 7 (the second embodiment).

FIG. 12 is a use register information storage unit 50 (the second embodiment).

FIG. 13 is a diagram provided for describing an operation of a simulation system 4 of the present invention (the second embodiment).

FIG. 14 is another diagram provided for describing an operation of a simulation system 4 of the present invention (the second embodiment).

FIG. 15 is a diagram showing an execution result 60 (the second embodiment).

FIG. 16 is a flowchart showing an operation of the simulation engine unit 7 (the second embodiment).

### DETAILED DESCRIPTION OF PREFERRED EMBODIMENTS

The invention will be now described herein with reference to illustrative embodiments. Those skilled in the art will recognize that many alternative embodiments can be accomplished using the teaching of the present invention and that the invention is not limited to the embodiments illustrated for explanatory purposes.

### First Embodiment

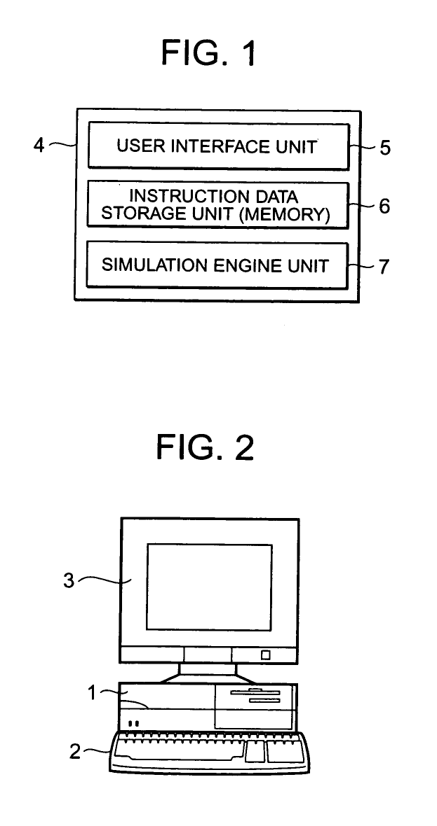

FIG. 1 is a diagram showing a configuration of a simulation system 4 according to the present invention. The simulation system 4 includes a user interface unit 5, an instruction data storage unit 6 and a simulation engine unit (simulation program) 7. The user interface unit 5 controls an input from an input device and an output to an output device. The instruction data storage unit 6 includes a debug target program stored therein. The simulation engine unit 7 reads out the debug target program from the instruction data storage unit 6 and processes an instruction set written in the debug target program.

The simulation engine unit 7 can be implemented as a computer program (simulation program) to be installed on a computer. FIG. 2 is a diagram showing a configuration of the computer. The computer includes an input device 2, an output device 3 and a main body 1. The input device 2 and output device 3 are connected to the main body 1. The input device 2 includes a keyboard and a pointing device. The output device 3 includes a display device and a printer.

The aforementioned main body 1 of the computer includes an unillustrated storage device and an unillustrated central processing unit (CPU). The simulation engine unit 7 is installed on the storage device. In this case, the debug target program stored in the instruction data storage unit 6 is also installed on the storage device. The simulation engine unit 7 (simulation program) reads out the debug target program from the storage device and processes an instruction set written in the debug target program on the CPU.

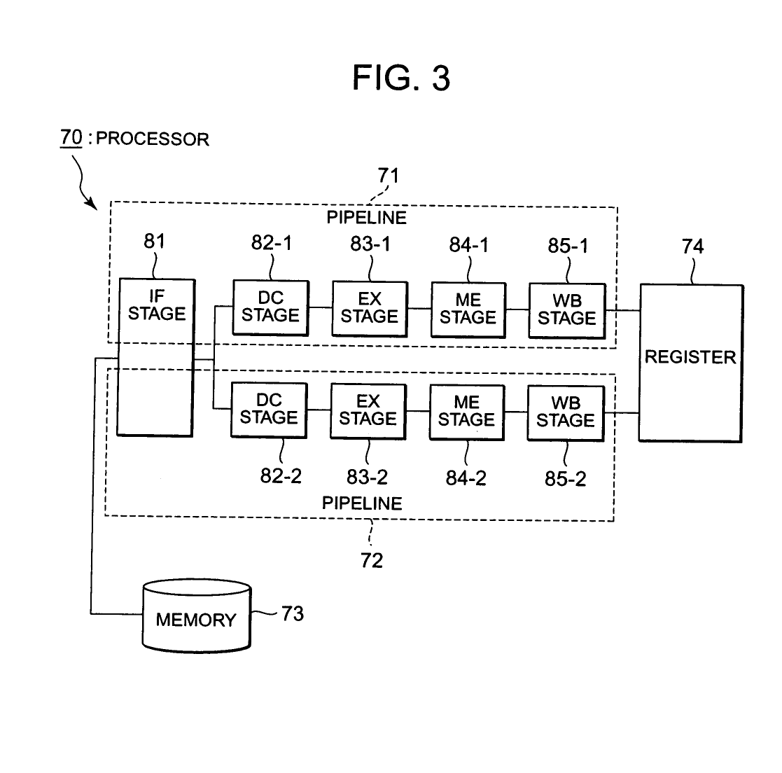

A developer utilizes the simulation engine unit 7 as a software program for analyzing or debugging a program to be operated on the processor. FIG. 3 is a schematic diagram showing a pipeline portion of a processor 70, the operation of which is to be simulated by use of the present invention. The processor 70 includes a memory 73 including an instruction set and data stored therein, a register 74 including a plurality of general purpose registers and two pipelines 71 and 72.

The processor 70 operates in response to a clock and furthermore, includes an instruction fetch (IF) stage 81 for fetching an instruction set, decode (DC) stages 82-1 and 82-2 each for decoding the fetched instruction, execution (EX) stages 83-1 and 83-2 each for executing the decoded instruction, memory access (MA) stages 84-1 and 84-2 each for performing an access to the memory 73 in response to an instruction (memory access instruction), and write back (WB) stages 85-1 and 85-2 each for writing an execution result of the instruction into the register 74. The processor 70 includes a pipeline 71 configured of the IF stage 81, the DC stage 82-1, the EX stage 83-1, the ME stage 84-1 and the WB stage 85-1, and a pipeline 72 configured of the IF stage 81, the DC stage 82-2, the EX stage 83-2, the ME stage 84-2 and the WB stage 85-2.

An instruction set n to be executed by the processor 70, for example, includes “ADD, MOV, SUB, JMP and LD.” Moreover, mnemonic descriptions, “LD,” “ADD,” “SUB,” “JMP,” and “MOV” respectively indicate a load instruction, an addition instruction, a subtraction instruction, a jump instruction and a move instruction for writing data from the memory 73 into the register 74. A program operated on the processor 70 is formed of these instructions.

In a case of the processor 70 shown in FIG. 3, since the processor 70 includes the two pipelines 71 and 72, the processing speed of the processor 70 can be increased by processing fetched instructions in parallel by use of the two pipelines 71 and 72 as compared with a case where the processor 70 includes only the pipeline 71. Note that it is not necessarily the case that the configuration of the arithmetic units, such as an addition unit or subtraction unit, for performing processing in the pipeline 71 is the same as that in the pipeline 72. This is because the processor 70 provided with the arithmetic units prepared for the respective pipelines will suffer from the disadvantage of being considerably large although the processing speed thereof can be increased. This increase in size of the processor may not be a problem in the case of a processor to be implemented on a large computer. The size of the processor, however, is an important factor in the case of a processor to be installed in a small computer or a microcomputer for a home appliance and a vehicle. Specifically, the processor 70 can be assumed to employ a configuration in which an arithmetic unit for processing instructions, “LD,” “JMP” and “MOV,” is provided in only one of the pipelines, which is the pipeline 71. In this case, for example, when a program to be operated on the processor 70 includes successive instructions, “JMP and MOV”, these instructions cannot be executed in parallel in the two pipelines 71 and 72 in the processor 70, due to the limitation of the pipelines. For this reason, the processor 70 performs sequential processing in which the instruction “MOV” is executed in the pipeline 71 after the instruction “JMP” is executed in the pipeline 71. In this embodiment, a description will be given of a technique for simulating the processor 70 configured in this manner. It should be noted that the processor 70 including an arithmetic unit for processing the aforementioned instructions, “LD,” “JMP,” and “MOV,” in only one of the pipelines, which is the pipeline 71, is merely cited for the purpose of simplifying the description.

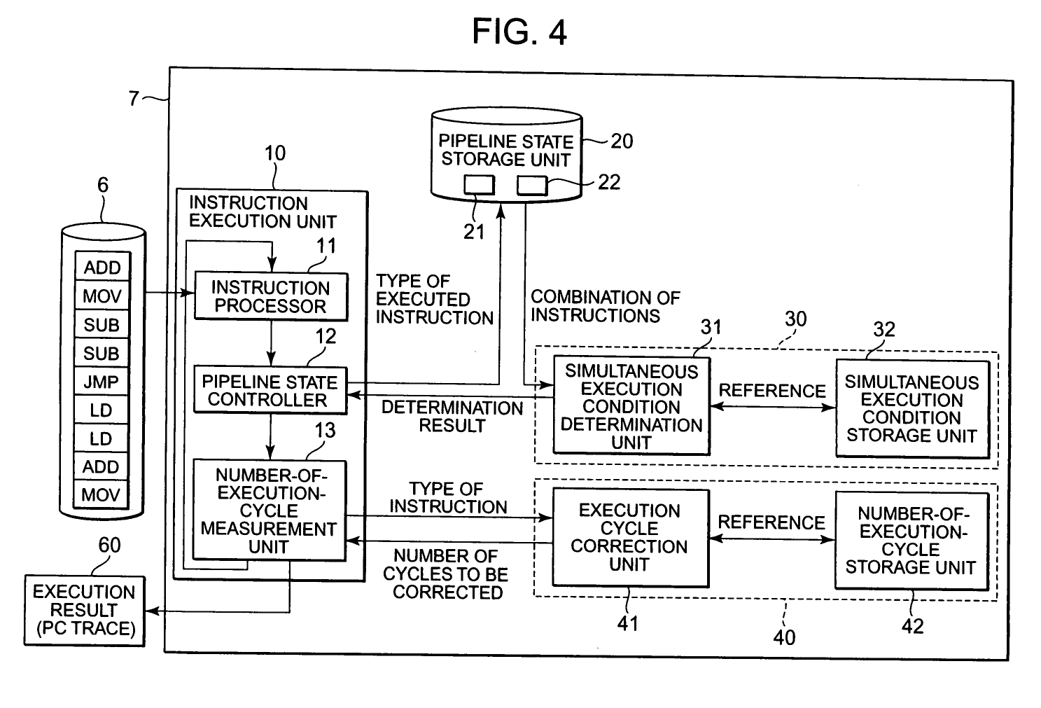

FIG. 4 is a diagram showing a configuration of the simulation engine unit 7. The simulation engine unit 7 includes an instruction execution unit 10, a pipeline state storage unit 20, a simultaneous execution instruction search unit 30 and an execution cycle changing unit 40. The instruction execution unit 10 includes an instruction processor 11, a pipeline state controller 12 and a number-of-execution-cycle measurement unit 13. The pipeline state storage unit 20 includes pipeline state storage sub units 21 and 22. The pipeline state storage sub units 21 and 22 respectively correspond to the aforementioned pipelines 71 and 72. The simultaneous execution instruction search unit 30 includes a simultaneous execution condition determination unit 31 and a simultaneous execution condition storage unit 32. The execution cycle changing unit 40 includes an execution cycle correction unit 41 and a number-of-execution-cycle storage unit 42. Since functions of the instruction processor 11 in the instruction execution unit 10 are equivalent to the functions included in the aforementioned ISS, the description of the instruction processor 11 is omitted here. In the meantime, since the pipeline state controller 12 and the number-of-execution-cycle measurement unit 13 are characteristic portions of the present invention, hereinafter, the descriptions will be given mainly of these two units.

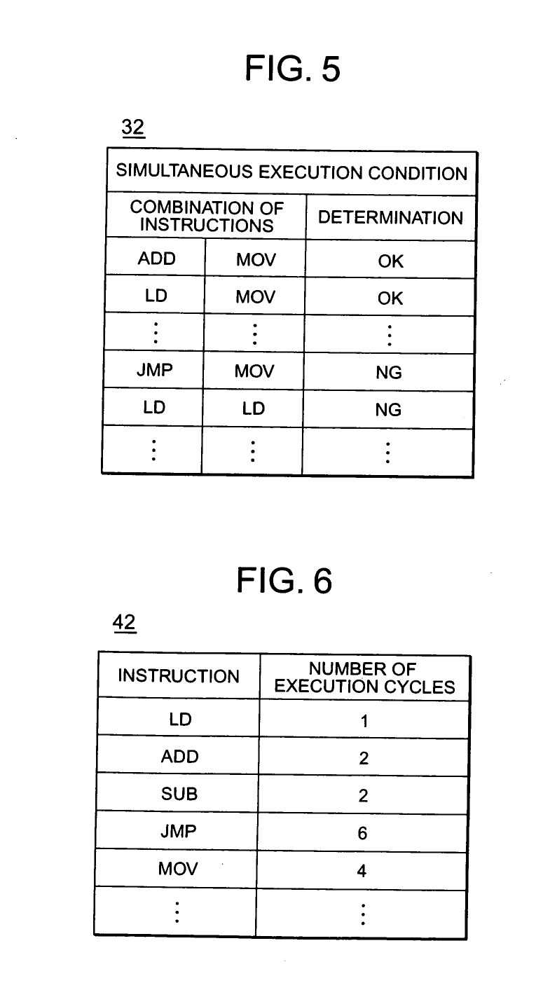

FIG. 5 is a diagram showing the simultaneous execution condition storage unit 32. The simultaneous execution condition storage unit 32 previously stores simultaneous execution conditions representing whether or not combinations of instructions simultaneously executable by the processor 70 using the pipelines 71 and 72. The simultaneous execution conditions are previously determined as the limitation of the pipelines. The simultaneous execution condition storage unit 32 stores, for example, information including combinations of instructions, “ADD, MOV,” “LD, MOV,” . . . , and corresponding determinations “OK,” indicating that the respective combinations of instructions are simultaneously executable. Moreover, the simultaneous execution condition storage unit 32 also stores information including combinations of instructions, “JMP, MOV,” “LD, LD,” . . . , and corresponding determinations, “NG,38 indicating that the respective combinations of the instructions are not simultaneously executable.

FIG. 6 is a diagram showing the number-of-execution-cycle storage unit 42. The number-of-execution-cycle storage unit 42 previously stores information including a plurality of instructions, and the corresponding numbers of execution machine cycles each indicating the number of machine cycles (clock cycles) which the EX stage for each of the plurality of instructions takes to execute. For example, the number-of-execution-cycle storage unit 42 stores the plurality of instructions “LD, ADD, SUB, JMP, MOV, . . . ” and the corresponding numbers of execution machine cycles, “1, 2, 2, 6, 4, . . . ” respectively. For the convenience of describing the present embodiment, extremely large values as compared with actual ones are used as the the numbers of execution machine cycles herein. These values are determined by the actual processing speed of the processor 70. The actual processing speed of the processor 70 can be determined by previously measuring the actual processing speed the processor 70, or previously determined on the basis of the design specification of the processor 70, for example.

The instruction processor 11 reads out a debug target program from a storage device (corresponding to the instruction data storage unit 6) in response to an operation performed by a developer with the input device 2. For the purpose of simplifying the descriptions, only an instruction set included in the debug target program are shown in FIG. 4. Furthermore, an assumption is made that the debug target program is a program that processes the instruction set in the order of “ADD, MOV, SUB, SUB, JMP, LD, LD, ADD and MOV.” The instruction processor 11 sequentially reads out the instructions, “ADD, MOV, SUB, SUB, JMP, LD, LD, ADD and MOV,” from the storage unit (corresponding to the instruction data storage unit 6) and outputs the instructions to the pipeline state controller 12 while executing the processing in accordance with each of the instructions. The pipeline state controller 12 outputs the instruction set to the simultaneous execution condition determination unit 31 in order to cause the simultaneous execution condition determination unit 31 to execute simultaneous execution instruction search processing for searching for a combination of instructions that can be simultaneously executed.

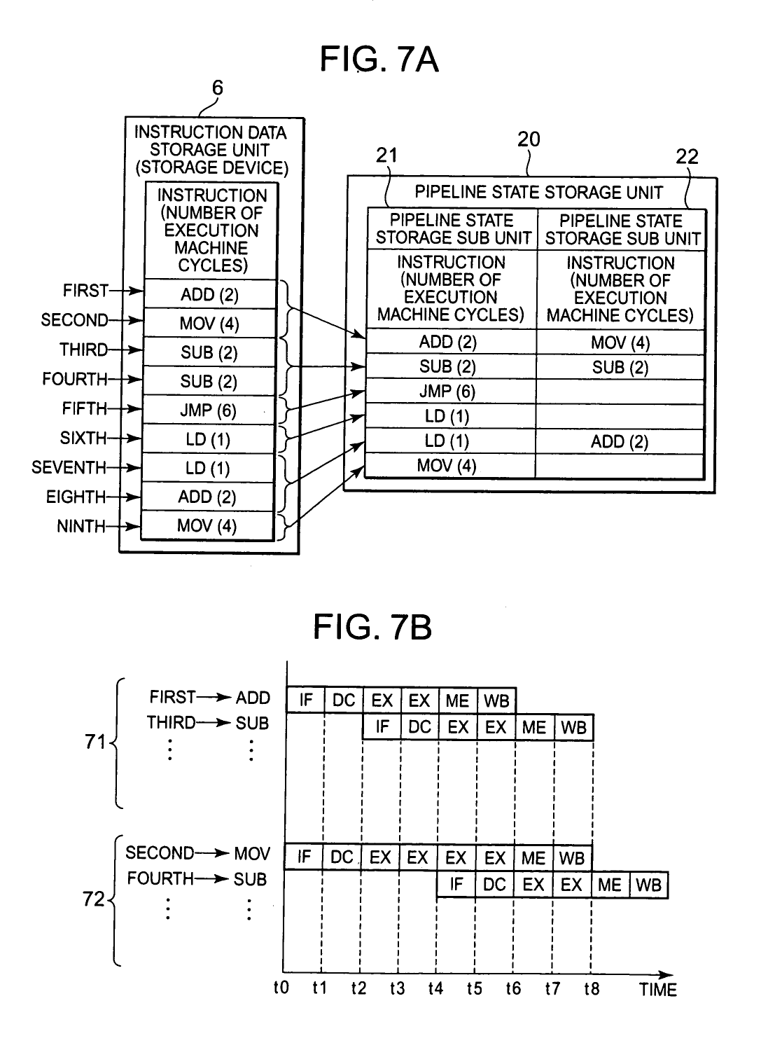

In the simultaneous execution instruction search processing, as shown in FIG. 7A, the simultaneous execution condition determination unit 31 divides, with reference to the simultaneous execution condition storage unit 32, the set of the first to the last instructions “ADD, MOV, SUB, SUB, JMP, LD, LD, ADD and MOV” to be processed one instruction at a time into the first to the last execution instruction sets, “ADD, MOV,” “SUB, SUB,” “JMP, _,” “LD, _,” “LD, ADD” and MOV, _.” The symbol “₁₃ ” indicates an instruction not executed according to the simultaneous conditions. Each of the plurality of execution instruction sets, “ADD, MOV,” “SUB, SUB,” “JMP, _,” “LD, _,” “LD, ADD” and MOV, _,” indicates a combination of instructions executable simultaneously inpipelines 71 and 72 by the processor 70. The simultaneous execution condition determination unit 31 causes the pipeline state storage unit 20 to store the first to the last execution instruction sets, “ADD, MOV,” “SUB, SUB,” “JMP, _,” “LD, _,” “LD, ADD” and MOV, _,” in this order. At this time, the simultaneous execution condition determination unit 31 causes the pipeline state storage sub unit 21 to store the former instruction of each of the execution instruction sets, “ADD, MOV,” “SUB, SUB,” “JMP, _,” “LD, _,” “LD, ADD” and MOV, _,” and the pipeline state storage sub unit 22 to store the latter instruction of each of the execution instruction sets, and thereafter notifies the pipeline state controller 12 of the completion of the simultaneous execution instruction search processing.

The numbers of execution machine cycles of the execution instruction sets, “ADD, MOV,” “SUB, SUB,” “JMP, _,” “LD, _,” “LD, ADD” and MOV, _,” are respectively, “2, 4,” “2, 2,” “6, _{—},” “1, _{—},” “1, 2,” and “4, _.” Then, for example, the processor 70 executes the IF stage 81, the DC stage 82-1, the EX stage 83-1, the ME stage 84-1 and the WB stage 85-1 in the pipeline 71, for the former instruction of each of the execution instruction sets “ADD, MOV,” “SUB, SUB,” “JMP, _,” “LD, _,” “LD, ADD” and MOV, _,” while executing the IF stage 81, the DC stage 82-2, the EX stage 83-2, the ME stage 84-2 and the WB stage 85-2 in the pipeline 72, for the latter instruction of each of the execution instruction sets. At this time, in a case where the processor 70 simultaneously executes the first execution instruction “ADD” and the second execution instruction “MOV,” the completion times of two instructions are different since the numbers of execution machine cycles which the EX stages 83-1 and 83-2 for the execution instructions “ADD” and “MOV” take to execute are respectively “2 and 4.” As shown in FIG. 7B, if the time when the first execution instruction “ADD” and the second execution instruction “MOV” start to be executed is set to t0, the execution of the first execution instruction “ADD” completes first at time t6, while the second execution instruction “MOV” is being executed. Then the execution of the second execution instruction “MOV” and the third execution instruction “SUB” complete simultaneously at the time t8. Specifically, with respect to the set of the first to the last instructions “ADD, MOV, SUB, SUB, JMP, LD, LD, ADD and MOV,” to be processed one instruction at a time, the third execution instruction “SUB” can be executed before the second execution instruction “MOV”. Therefore, it is necessary to correct the numbers of execution machine cycles.

In order to cause the execution cycle search processing for correcting the numbers of execution machine cycles to be executed, the pipeline state controller 12 reads out the execution instruction sets “ADD, MOV,” “SUB, SUB,” “JMP, _,” “LD, _, ” “LD, ADD” and MOV, _” stored in the pipeline state storage sub units 21 and 22, and then outputs the execution instruction sets to the number-of-execution-cycle measurement unit 13. The number-of-execution-cycle measurement unit 13 then outputs the execution instruction sets to the execution cycle correction unit 41.

In the execution cycle search processing, the execution cycle correction unit 41 receives the execution instruction sets, “ADD, MOV,” “SUB, SUB,” “JMP, _,” “LD, _,” “LD, ADD” and MOV, _,” from the number-of-execution-cycle measurement unit 13. Alternatively, the execution cycle correction unit 41 may also refer to the pipeline state storage sub units 21 and 22 when receiving the notification that causes the execution cycle search processing to be executed from the number-of-execution-cycle measurement unit 13. Then the execution cycle correction unit 41 refers to the number-of-execution-machine-cycle storage unit 42, and performs a search to find, from the numbers of execution machine cycles, “2, 4,” “2, 2,” “6, _{—},” “1, _{—},” “1, 2,” and “4, _,” of the execution instruction sets “ADD, MOV,” “SUB, SUB,” “JMP, _,” “LD, _,” “LD, ADD” and MOV, _,” to be executed in the pipelines 71 and 72, the maximum numbers of the execution machine cycles, “4,” “2,” “6,” “1,” “2” and “4,” each of which is the largest number of the execution machine cycles of each of the execution instruction sets. According to the search result, the execution machine cycle correction unit 41 changes the numbers of execution machine cycles, “2, 4,” “2, 2,” “6, _{—},” “1, _{—},” “1, 2,” and “4, _,” of the execution instruction sets, “ADD, MOV,” “SUB, SUB,” “JMP, _,” “LD, _,” “LD, ADD” and MOV, _,” to the maximum numbers of the execution machine cycles “4,” “2,” “6,” “1,” “2” and “4.” The execution machine cycle correction unit 41 outputs the maximum numbers of the execution machine cycles “4,” “2,” “6,” “1,” “2” and “4,” to the instruction execution unit 10 and notifies the instruction execution unit 10 of the completion of the execution cycle search processing.

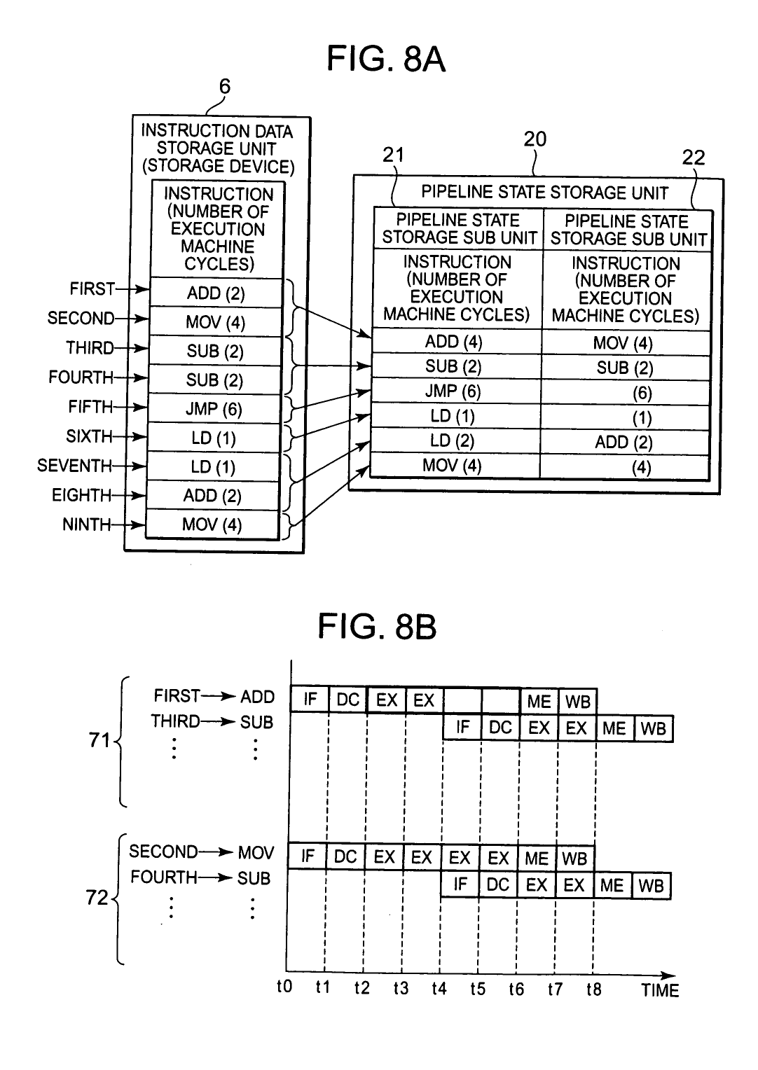

At this time, as shown in FIG. 8A, the pipeline state controller 12 of the instruction execution unit 10 updates the numbers of the execution machine cycles of the execution instruction sets “ADD, MOV,” “SUB, SUB,” “JMP, _,” “LD, _,” “LD, ADD” and “MOV, _,” from the numbers, “2, 4, “2, 2,” “6, _{—},” “1, _{—},” “1, 2,” and “4, _,” stored in the pipeline state storage subunits 21 and 22 to the maximum numbers of the execution machine cycles “4,” “2,” “6,” “1,” “2” and “4,” and outputs the updated numbers of the execution machine cycles to the number-of-execution-cycle measurement unit 13 of the instruction execution unit 10.

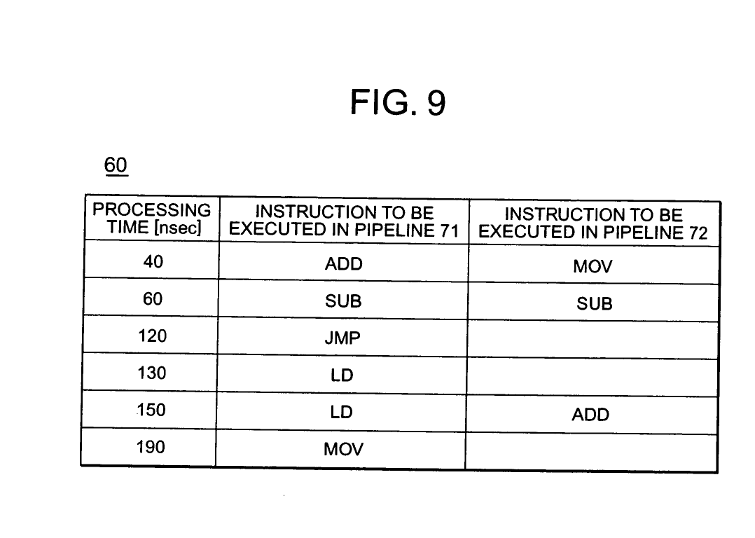

The number-of-execution-cycle measurement unit 13 outputs an execution result 60 as shown in FIG. 9 to the output device 3. The execution result 60 includes the execution instructions “ADD, SUB, JMP, LD, LD, MOV, and MOV” stored in the pipeline state storage sub unit 21, “MOV, SUB, _, _, ADD and _” stored in the pipeline state storage sub unit 22, and the total value “19” of the numbers of the execution machine cycles, “4, 2, 6, 1, 2, and 4.” This total value “19” is smaller than the total value “24” of the numbers of the execution machine cycles, “2, 4, 2, 2, 6, 1, 1, 2 and 4” of the instruction set “ADD, MOV, SUB, SUB, JMP, LD, LD, ADD and MOV.” Moreover, when one clock period is assumed to be 10 [nsec], the aforementioned total value “19” corresponds to the processing time [nsec]. Then, the processing times [nsec] for the execution instructions “ADD, SUB, JMP, LD, LD and MOV” and “MOV, SUB, _, _, ADD and _” are respectively indicated by “40, 60, 120, 130, 150 and 190” [nsec]. Here, an extremely larger value than the actual one is used as the clock period for the convenience of describing the present embodiment.

The processor 70 includes the plurality of pipelines 71 and 72 in order to increase the instruction processing speed. Accordingly, in developing a program to be operated on such a processor 70, a simulation technique taking the pipelines 71 and 72 into consideration is desired as well. However, in a case where the configurations of the pipelines 71 and 72 are not quite the same, and where the arithmetic units provided in the respective pipelines 71 and 72 are different, it is difficult to simply apply the technique disclosed in Japanese Patent Application Laid-open Publication No. 2001-290857 to the pipelines 71 and 72.

In this respect, the simulation system 4 according to the first embodiment of the present invention, among the instruction set “ADD, MOV, SUB, SUB, JMP, LD, LD, ADD, and MOV, ” first searches for the combinations of instructions that can be executed simultaneously in the pipelines 71 and 72 by the processor 70 to find the execution instruction sets, “ADD, MOV,” “SUB, SUB,” “JMP, _,” “LD, _,” “LD, ADD” and “MOV, _.” Then, the simulation system 4 changes the numbers of execution machine cycles, “2, 4,” “2, 2,” “6, _{—},” “1, _{—}” “1, 2” and “4, _,” of the execution instruction sets, “ADD, MOV,” “SUB, SUB,” “JMP, _,” “LD, _,” “LD, ADD” and “MOV, _,” to the maximum numbers of the execution machine cycles “4,” “2,” “6,” “1,” “2” and “4,” in the light of the processing order of the instruction set “ADD, MOV, SUB, SUB, JMP, LD, LD, ADD and MOV.” As described above, by use of the simulation system 4 according to the first embodiment of the present invention which performs a search to find execution instruction sets that can be executed simultaneously in the pipelines 71 and 72 by the processor 70, and which then changes the numbers of execution machine cycles of the execution instruction sets to the maximum numbers of the execution machine cycles, the operation of the processor 70 can be simulated while the plurality of pipelines (pipeline sets 71 and 72) are taken into consideration.

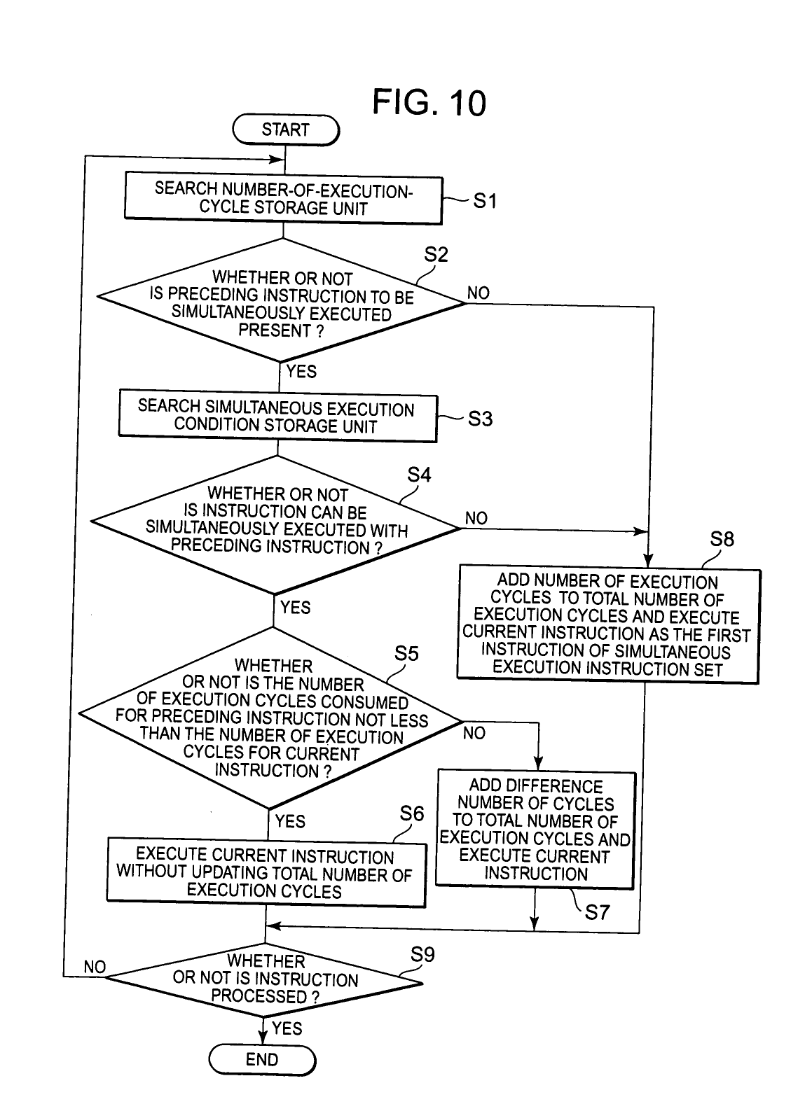

FIG. 10 is a flowchart showing an operation of the simulation engine unit 7.

First, the instruction processor 11 reads out the first instruction “ADD” from the instruction data storage unit 6. At the same time, the number-of-execution-cycle measurement unit 13 controls the execution cycle correction unit 41 so that the execution cycle correction unit 41 can refer to the number-of-execution-cycle storage unit 42 and obtain the number of execution machine cycle “2” of the first instruction “ADD” (step S1). As the simultaneous execution instruction search processing, the pipeline state controller 12 controls the simultaneous execution condition determination unit 31 so that the first instruction “ADD” can be stored as the first record in the pipeline state storage sub unit 21 (step S2—NO) At this time, the number-of-execution-cycle measurement unit 13 adds, as an execution result 60, the number of execution machine cycles “2” of the first instruction “ADD” to the total number of execution machine cycles “0” of the first execution instruction set (step S8).

Next, the instruction processor 11 reads out the second instruction “MOV” from the instruction data storage unit 6 (step S9—NO) At the same time, the number-of-execution-cycle measurement unit 13 controls the execution cycle correction unit 41 so that the execution cycle correction unit 41 can refer to the number-of-execution-cycle storage unit 42 and obtain the number of execution machine cycles “4” of the second instruction “MOV” (step S1) Here, the first instruction “ADD” is stored as the first record in the pipeline state storage sub unit 21 (step S2—YES) Then, as the simultaneous execution instruction search processing, the pipeline state controller 12 controls the simultaneous execution condition determination unit 31 so that the simultaneous execution condition determination unit 31 can refer to the simultaneous execution condition storage unit 32 (step S3). As a result of the search, the first instruction (the preceding instruction of the execution instruction set) “ADD” and the second instruction “MOV” prove to be able to be simultaneously executed (step S4—YES). In response to this result, the simultaneous execution condition determination unit 31 causes the second instruction “MOV” to be stored as the first record in the pipeline state storage sub unit 22 while associating the second instruction “MOV” with the first instruction “ADD” stored in the pipeline state storage sub unit 21, as the first execution instruction set “ADD, MOV.” The number of execution machine cycles “2” of the first instruction (the preceding instruction of the execution instruction set) “ADD” is smaller than the number of execution cycles “4” of the second instruction (the current instruction) “MOV” (step S5—NO). Specifically, the number of execution machine cycles “4” of the second instruction “MOV” is the maximum number of the execution machine cycles “4.” At this time, as the execution cycle search processing, the number-of-execution-machine-cycle measurement unit 13 controls the execution machine cycle correction unit 41 so that the number of execution machine cycles “2” of the first instruction “ADD” is changed to the maximum number of the execution machine cycles “4.” At the same time, the number-of-execution-cycle measurement unit 13 adds, as the execution result 60, a difference “2” between the maximum number of the execution machine cycles “4” and the number of execution cycles “2” of the first instruction “ADD” to the total number of execution machine cycles “2” of the first execution instruction set (step S7).

On the other hand, consider a case where the number of execution machine cycles of the preceding instruction of the execution instruction set is not less than the number of execution machine cycles of the current instruction (step S5—YES). In this case, the execution machine cycle correction unit 41 does not change the number of execution machine cycles of the preceding instruction of the execution instruction set. At the same time, the number-of-execution-machine-cycle measurement unit 13 does not update either, as the execution result 60, the total number of execution machine cycles of the execution instruction set including the preceding instruction and the current instruction (step S6).

The simulation engine unit 7 executes the aforementioned operation repeatedly until the operations for the first to the last (the ninth) instructions “ADD, MOV, SUB, SUB, JMP, LD, LD, ADD and MOV” completes (step S9—YES).

As described above, by use of the simulation system 4 according to the first embodiment of the present invention which performs a search to find execution instruction sets that can be executed simultaneously in the pipelines 71 and 72 by the processor 70, and which then changes the numbers of execution machine cycles of the execution instruction sets to the maximum numbers of the execution machine cycles, the operation of the processor 70 can be simulated while the plurality of pipelines (pipeline sets 71 and 72) are taken into consideration.

### Second Embodiment

In the descriptions to be provided below for a simulation system 4 according to a second embodiment of the present invention, a description that overlaps with that in the first embodiment will be omitted.

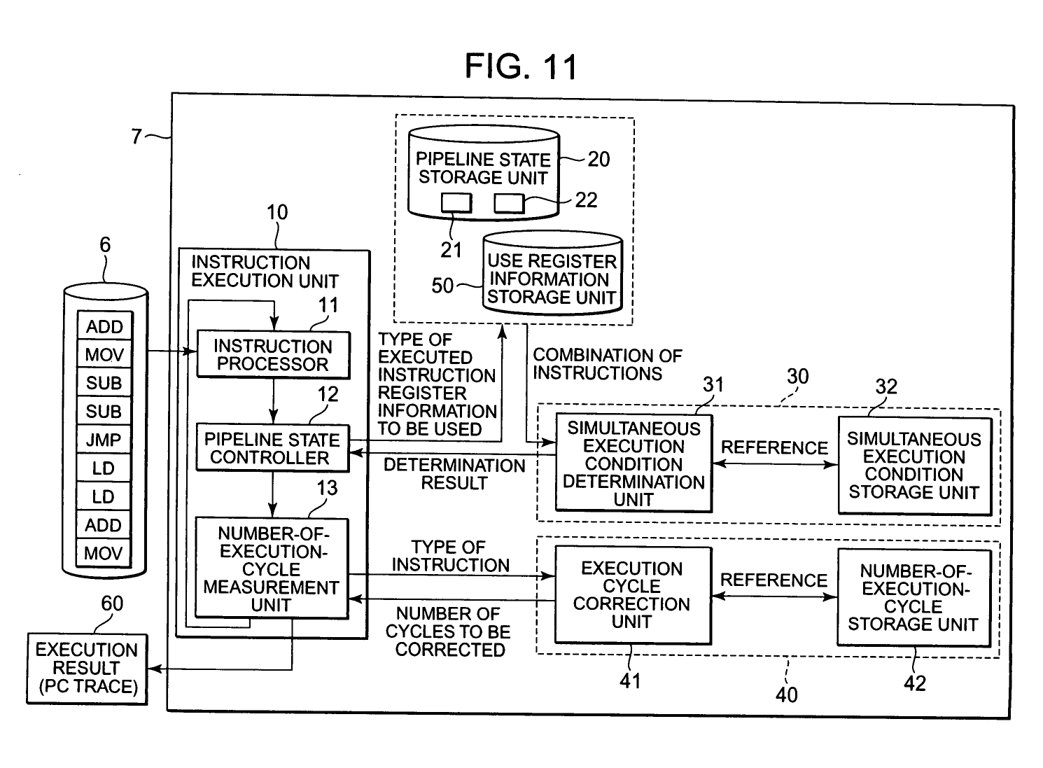

FIG. 11 is a diagram showing a configuration of the simulation engine unit 7. The simulation engine unit 7 of the second embodiment further includes a use register information storage unit 50.

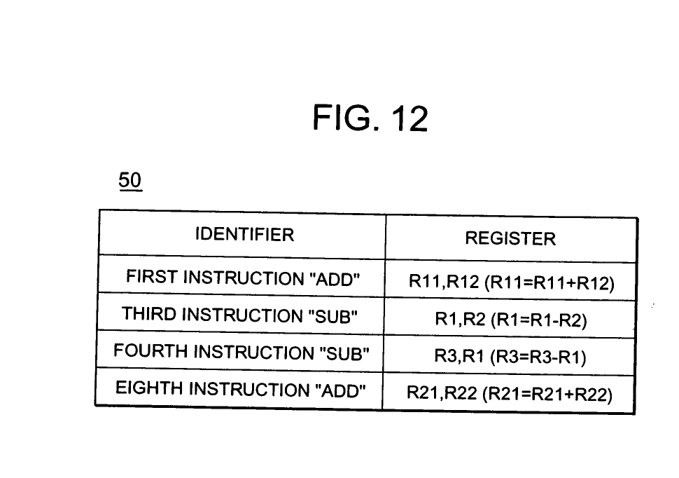

FIG. 12 is a diagram showing the use register information storage unit 50. The use register information storage unit 50 stores information including identifiers for identifying respective arithmetic instructions and register names used when the respective arithmetic instructions are executed. The register names used here are registers 74 included in the processor 70 of the simulation target and are used when the debug target program executes the respective arithmetic instructions. Consider a case where the debug target program is formed of instructions “ADD, MOV, SUB, SUB, JMP, LD, LD, ADD, and MOV,” for example. Furthermore, in this case, consider that the arithmetic operations of “ADD, SUB, SUB and ADD” are respectively defined as “ADD R11, R12 (meaning R11=R11+R12),” “SUB R1, R2 (meaning R1=R1−R2),” “SUB R3, R1 (meaning R3=R3−R1)” and “ADD R21, R22 (meaning R21=R21+R22).” In this case, the identifiers for identifying the respective arithmetic operations and the corresponding register names are stored in the use register information storage unit 50.

In response to an operation performed by a developer with the input device 2, the instruction processor 11 reads out the instruction set “ADD, MOV, SUB, SUB, JMP, LD, LD, ADD, and MOV” from a storage device (corresponds to the instruction data storage unit 6) and then outputs the instruction set to the pipeline state controller 12 while outputting register names used for the respective instructions and identifiers for identifying the respective instructions to the use register information storage unit 50. The pipeline state controller 12 outputs the instruction set to the simultaneous execution condition determination unit 31 in order to cause the simultaneous execution condition determination unit 31 to execute simultaneous execution instruction search processing for searching for a combination of instructions that can be simultaneously executed.

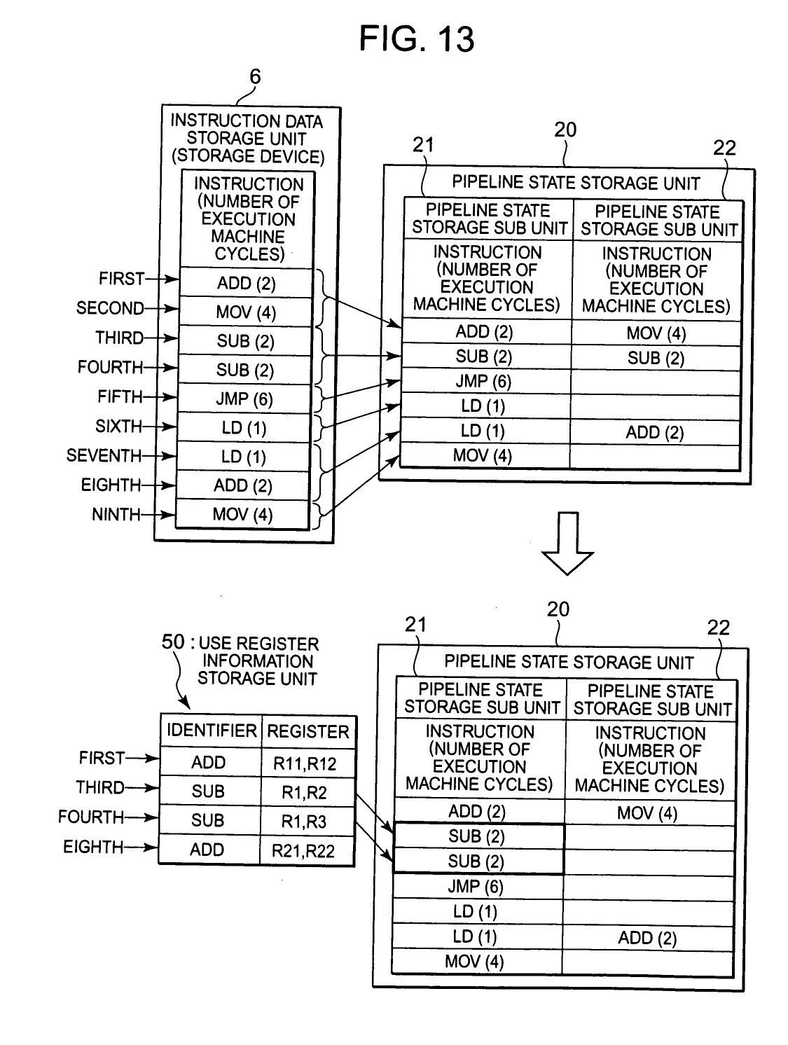

In the simultaneous execution instruction search processing, as shown in FIG. 13, the simultaneous execution condition determination unit 31 divides, with reference to the simultaneous execution condition storage unit 32, the set of the first to the last instructions “ADD, MOV, SUB, SUB, JMP, LD, LD, ADD and MOV” to be processed one instruction at a time into a plurality of first to-last execution instruction sets “ADD, MOV,” “SUB, SUB,” “JMP, _,” “LD, _,” “LD, ADD” and MOV, _.” The symbol ” indicates an instruction not executed according to the simultaneous conditions. Each of the plurality of execution instruction sets, “ADD, MOV,” “SUB, SUB,” “JMP, _,” “LD, _,” “LD, ADD” and MOV, _,” indicates a combination of instructions executable simultaneously in the pipelines 71 and 72 by the processor 70. The simultaneous execution condition determination unit 31 causes the pipeline state storage unit 20 to store the first to the last execution instruction sets, “ADD, MOV,” “SUB, SUB,” “JMP, _,” “LD, _,” “LD, ADD” and MOV, _,” in this order. At this time, the simultaneous execution condition determination unit 31 causes the pipeline state storage sub unit 21 to store the former instruction of each of the execution instruction sets, “ADD, MOV,” “SUB, SUB,” “JMP, _,” “LD, _,” “LD, ADD” and MOV, _,” and the pipeline state storage sub unit 22 to store the latter instruction of each of the execution instruction sets.

Next, the simultaneous execution condition determination unit 31 refers to the pipeline state storage sub units 21 and 22 and the use register information storage unit 50, and performs a search to find out whether or not each of the execution instruction sets, “ADD, MOV,” “SUB, SUB,” “JMP, _,” “LD, _,” “LD, ADD” and MOV, _,” is an arithmetic execution instruction sets to use the same register for performing the arithmetic operations. As a result of the search, it is found that the execution instruction set “SUB, SUB” is the arithmetic execution instruction set to use the same register, “R1” for performing the respective arithmetic operations, “R1=R1−R2” and “R3=R3−R1.” Specifically, since the arithmetic execution instruction set (SUB, SUB) is an instruction set to use the same register “R1,” the arithmetic execution instruction set cannot be executed at the same time. Such instructions that cannot be simultaneously executed since the instructions to use the same register are called hazard execution instructions.

With this respect, as shown in FIG. 13, the simultaneous execution condition determination unit 31 divides the arithmetic execution instruction set “SUB, SUB” into a plurality of first to last hazard execution instruction sets, “SUB, _” and “SUB, _.” Each of the plurality of hazard execution instruction sets, “SUB, _” and “SUB, _,” indicates a combination of instructions for not using the same register “R1” and the symbol “_” indicates an instruction not executed according to the simultaneous execution conditions. The simultaneous execution condition determination unit 31 causes one of the pipeline state storage sub units 21 and 22 (the pipeline state storage sub unit 21, for example) to store the hazard execution instruction sets “SUB, _,” and “SUB, _,” as the first to the last execution instruction sets in this order, in place of the arithmetic execution instruction set “SUB, SUB” stored in the pipeline state storage sub units 21 and 22. As a result, as the execution instruction sets, “ADD, MOV,” “SUB, _,” “SUB, _,” “JMP, _,” “LD, _,” “LD, ADD,” and “MOV, _” are stored in the pipeline state storage sub units 21 and 22. The simultaneous execution condition determination unit 31 notifies the pipeline state controller 12 of the completion of the simultaneous execution instruction search processing.

In order to cause the execution cycle search processing for correcting the numbers of execution machine cycles to be executed, the pipeline state controller 12 reads out the execution instruction sets, “ADD, MOV, ” “SUB, _,”“SUB, _,” “JMP, _,” “LD, _,” “LD, ADD,” and “MOV, _,” stored in the pipeline state storage sub units 21 and 22 and then outputs the execution instruction sets to the number-of-execution-cycle measurement unit 13. The number-of-execution-cycle measurement unit 13 then outputs the execution instruction sets to the execution cycle correction unit 41.

In the execution cycle search processing, the execution cycle correction unit 41 receives the execution instruction sets, “ADD, MOV,” “SUB, _, SUB, _,” “JMP, _,” “LD, _,” “LD, ADD” and MOV, _,” from the number-of-execution-cycle measurement unit 13. Alternatively, the execution cycle correction unit 41 may also refer to the pipeline state storage sub units 21 and 22 when receiving the notification that causes the execution cycle search processing to be executed from the number-of-execution-cycle measurement unit 13. Then the execution cycle correction unit 41 refers to the number-of-execution-machine-cycle storage unit 42, and performs a search to find, from the numbers of execution machine cycles, “2, 4,” “2, _{—},” “2, _{—},” “6, _{—},” “1, _{—}, ” “1, 2,” and “4, _,” of the execution instruction sets “ADD, MOV,” “SUB, _,” “SUB, _,” “JMP, _, “LD, _,” “LD, ADD” and MOV, _,” to be executed on the pipelines 71 and 72, the maximum numbers of the execution machine cycles, “4,” “2,” “2,” “6,” “1,” “2” and “4,” each of which is the largest number of the execution machine cycles of each of the execution instruction sets. According to the search result, the execution machine cycle correction unit 41 changes the numbers of execution machine cycles, “2, 4,” “2, _{—},” “2, _{—},” “6, _{—},” “1, _{—},” “1, 2,” and “4, _,” of the execution instruction sets, “ADD, MOV,” “SUB, _,” “SUB, _,” “JMP, _,” “LD, _,” “LD, ADD” and MOV, _,” to the maximum numbers of the execution machine cycles, “4,” “2,” “2,” “6,” “1,” “2” and “4.” The execution machine cycle correction unit 41 outputs the maximum numbers of the execution machine cycles “4,” “2,” “2,” “6,” “1,” “2” and “4,” to the instruction execution unit 10 and notifies the instruction execution unit 10 of the completion of the execution cycle search processing.

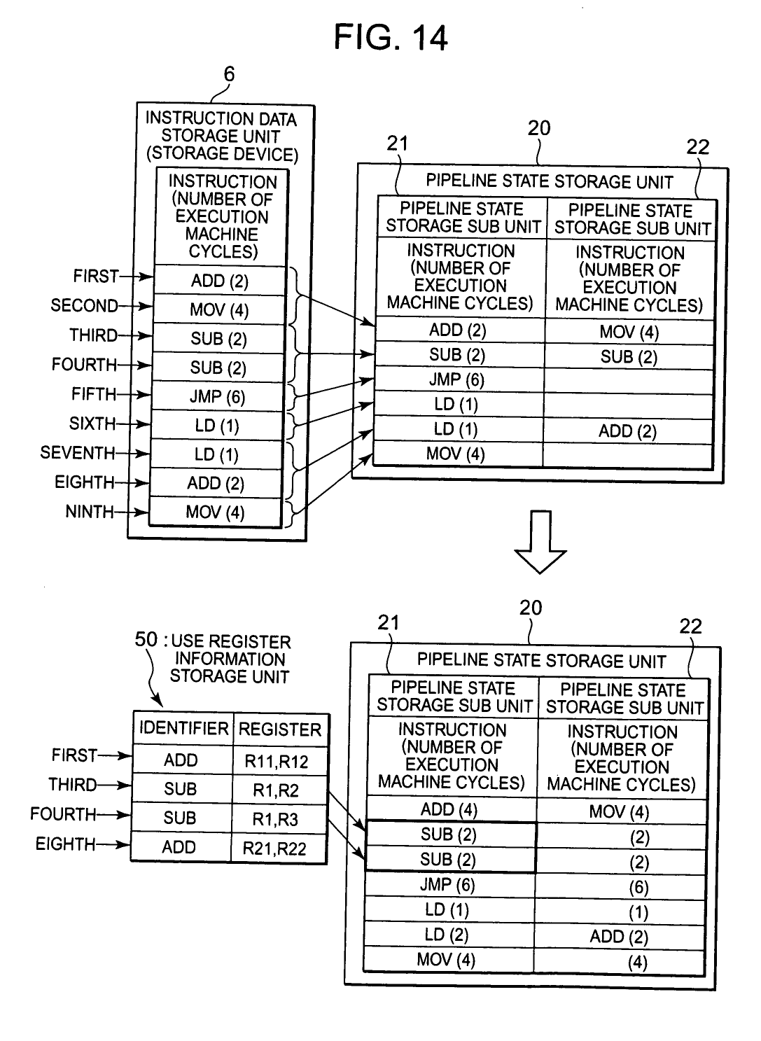

At this time, as shown in FIG. 14, the pipeline state controller 12 of the instruction execution unit 10 updates the numbers of the execution machine cycles of the execution instruction sets, “ADD, MOV,” “SUB, _,” “SUB, _,” “JMP, _,” “LD, _,” “LD, ADD,” and “MOV, _” from the numbers, “2, 4, “2, _{—},” “2, _{—},” “6, _{—},” “1, _{—},” “1, 2,” and “4, _,” stored in the pipeline state storage units 21 and 22 to the maximum numbers of the execution machine cycles “4,” “2,” “2,” “6,” “1,” “2” and “4,” and outputs the updated numbers of the execution machine cycles to the number of execution cycles measurement unit 13 of the instruction execution unit 10.

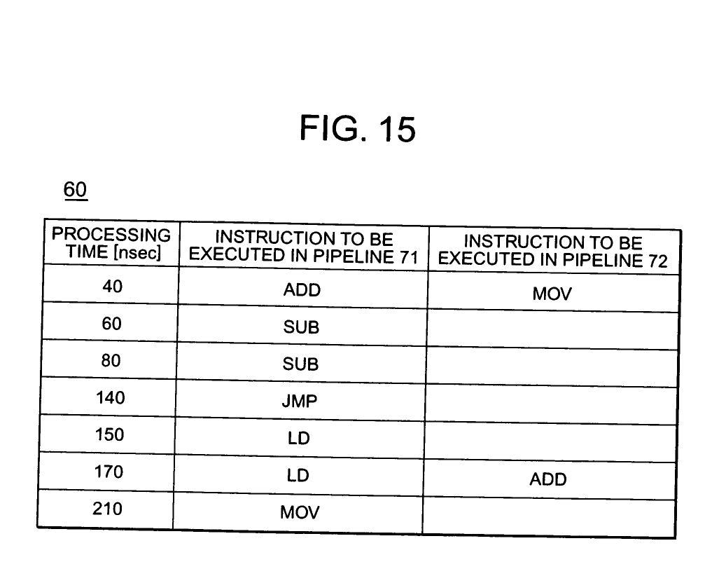

The number-of-execution-cycle measurement unit 13 outputs an execution result 60 as shown in FIG. 15 to the output device 3. The execution result 60 includes the execution instructions “ADD, SUB, SUB, JMP, LD, LD, and MOV” stored in the pipeline state storage sub unit 21, “MOV, _, _, _, _, ADD, and _” stored in the pipeline state storage sub unit 22, and the total value “21” of the numbers of the execution machine cycles, “4, 2, 2, 6, 1, 2, and 4.” This total value “21” is smaller than the total value “24” of the numbers of the execution machine cycles, “2, 4, 2, 2, 6, 1, 1, 2 and 4” of the instruction set “ADD, MOV, SUB, SUB, JMP, LD, LD, ADD and MOV.” Moreover, when one clock period is assumed to be 10 [nsec], the aforementioned total value “21” corresponds to the processing time [nsec]. Then, the processing times [nsec] for the execution instructions “ADD, SUB, SUB, JMP, LD, LD, MOV” and “MOV, _, _, _, _, ADD and _” are respectively indicated by “40, 60, 120, 130, 150 and 190” [nsec]. Here, an extremely larger value than the actual one is used as the clock period for the convenience of describing the present embodiment.

In the simulation system 4 according to the second embodiment of the present invention, for the instruction set “ADD, MOV, SUB, SUB, JMP, LD, LD, ADD, and MOV,” searches for the combinations of instructions that can be executed simultaneously in the pipelines 71 and 72 by the processor 70 to find the execution instruction sets, “ADD, MOV,” “SUB, SUB,” “JMP, _,” “LD, _,” “LD, ADD,” and “MOV, _” As described above, in a case where there is a rule in the processing order of the instructions, and where the execution instruction set, “SUB, SUB” is a instruction set to use the same register “R1” for performing the respective arithmetic operations “R1=R1−R2” and “R3=R3−R1,” the instructions cannot be simultaneously executed.

In this respect, the simulation system 4 according to the second embodiment of the present invention first searches for the combinations of instructions not to use the same register “R1” corresponding to the execution instruction set (arithmetic execution instruction set) “SUB, SUB” to fine the execution instruction sets (hazard execution instruction sets), “SUB, _,” and “SUB, _.” Then, the simulation system 4 changes the numbers of execution machine cycles, “2, 4,” “2, _{—}, ” “2, _{—},” “6, _{—},” “1, _{—},” “1, 2,” and “4, _,” of the execution instruction sets, “ADD, MOV,” “SUB, _,” “SUB, _,” ” JMP, _,” “LD, _,” “LD, ADD” and “MOV, _,” to the maximum numbers of the execution machine cycles “4,” “2,” “6,” “1,” “2” and “4” in the light of the processing order of the instruction set “ADD, MOV, SUB, SUB, JMP, LD, LD, ADD and MOV.” As described above, by use of the simulation system 4 according to the second embodiment of the present invention, which performs a search to find execution instruction sets to be executed simultaneously in the pipelines 71 and 72 by the processor 70, and execution instruction sets not to use the same register “R1”, and which then changes the numbers of execution machine cycles to the maximum numbers of the execution machine cycles, the operation of the processor 70 can be simulated while the plurality of pipelines (pipelines 71 and 72) are taken into consideration.

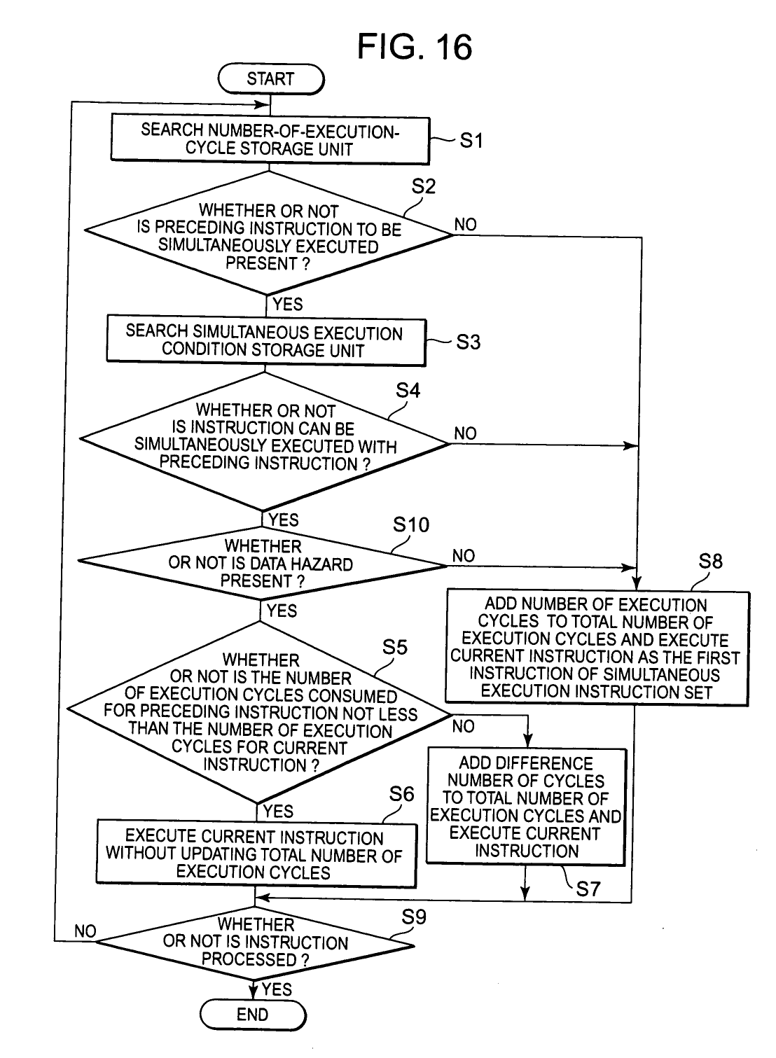

FIG. 16 is a flowchart showing an operation of the simulation engine unit 7.

As the first execution instruction set “ADD, MOV,” the first instruction is “ADD” is stored as the first record in the pipeline state storage sub unit 21, and the second instruction “MOV” is stored as the first record in the pipeline state storage sub unit 22.

Next, the instruction processor 11 reads out the third instruction “SUB” from the instruction data storage unit 6 (step S9—NO). At the same time, the number-of-execution-machine-cycle measurement unit 13 controls the execution cycle correction unit 41 so that the execution cycle correction unit 41 can refer to the number-of-execution-cycle storage unit 42 and obtain the number of execution machine cycles “2” of the third instruction “SUB” (step S1). Then, as the simultaneous execution instruction search processing, the pipeline state controller 12 controls the simultaneous execution condition determination unit 31 so that the pipeline state storage sub unit 21 can store the third instruction “SUB” as the second record (step S2—NO). At this time, the number-of-execution-cycle measurement unit 13 adds, as the execution result 60, the number of execution machine cycles “2” of the third instruction “SUB” to the total number of execution machine cycles “0” of the second execution instruction set (step S8)

Next, the instruction processor 11 reads out the fourth instruction “SUB” from the instruction data storage unit 6 (step S9—NO). At the same time, the number-of-execution-cycle measurement unit 13 controls the execution cycle correction unit 41 so that the execution cycle correction unit 41 can refer to the number-of-execution-cycle storage unit 42 and obtain the number of execution machine cycles “2” of the fourth instruction “SUB” (step S1). Here, the third instruction “SUB” is stored as the second record in the pipeline state storage sub unit 21 (step S2—YES). Then, as the simultaneous execution instruction search processing, the pipeline state controller 12 controls the simultaneous execution condition determination unit 31 so that the simultaneous execution condition determination unit 31 can refer to the simultaneous execution condition storage unit 32 (step S3) As a result of the search, the third instruction (preceding instruction set) “SUB” and the second instruction “SUB” prove to be able to be simultaneously executed (step S4—YES). In response to this result, the simultaneous execution condition determination unit 31 causes the fourth instruction “SUB” to be stored as the second record in the pipeline state storage sub unit 21 while associating the fourth instruction “SUB” with the third instruction “SUB” stored in the pipeline state storage sub unit 21, as the second instruction set “SUB, SUB.”.

In the simultaneous execution instruction search processing, the simultaneous execution condition determination unit 31 refers to the pipeline storage sub units 21 and 22 and the use register information storage unit 50, and performs a search to find out whether or not the third instruction (the preceding instruction of the execution instruction set) “SUB” and the fourth instruction (the current instruction) “SUB” are instructions to use the same register for performing arithmetic operations (step S10). According to the search result, it is found that since the third instruction “SUB” and the fourth instruction “SUB” are instructions to use the same register “R” for performing the respective arithmetic operations, “R1=R1−R2,” and “R3=R3−R1,” the third instruction “SUB” and the fourth instruction “SUB” cannot be simultaneously executed (step S10—NO). In this case, the simultaneous execution condition determination unit 31 causes the pipeline state storage sub unit 21 to store, as the second record, the third instruction “SUB” in the form of the second execution instruction set “SUB, _,” and, as the third record, the fourth instruction “SUB” in the form of the third execution instruction set “SUB, _,”, in place of the execution instruction set “SUB, SUB” stored in the second records of the respective pipeline state storage units 21 and 22. At this time, the number-of-execution-machine-cycle unit measurement unit 13 adds, as the execution result 60, the number of execution machine cycles “2” of the fourth instruction “SUB” to the number of total execution machine cycles “0” of the third execution instruction set (step S8).

On the other hand, in a case where the preceding instruction of the execution instruction set and the current instruction are instructions not to use the same register for performing the respective arithmetic operations (step S10—YES), the processing of aforementioned step S5 and the steps after step S5 are executed.

As described above, by use of the simulation system 4 according to the second embodiment of the present invention which performs searches to find execution instruction sets that can be executed simultaneously in the pipelines 71 and 72 by the processor 70 and to find execution instruction sets not to use the same register “R1”, and which then changes the numbers of the execution machine cycles of the execution instruction sets to the maximum numbers of the execution machine cycles, the operation of the processor 70 can be simulated while the plurality of pipelines (pipelines 71 and 72) are taken into consideration.

According to the first and the second embodiments of the present invention, for the purpose of clearly describing the characteristics thereof, the descriptions are given of the case where there are instructions that cannot be executed simultaneously in two pipelines. However, as a matter of course, even in a case where a target processor to be simulated includes a plurality of pipelines and where there are no instructions that cannot be executed simultaneously in the two pipelines; specifically, in a case where simultaneous execution condition is determined as “NG”, the simulation can be successfully performed.

It is apparent that the present invention is not limited to the above embodiments, but may be modified and changed without departing from the scope and sprit of the invention.

What is claimed is:

1. A simulation system for simulating an operation of a processor including a plurality of pipeline mechanisms, comprising:
an instruction processor which executes each of instructions included in an analysis target program formed of an instruction set executable by the processor;
a simultaneous execution condition determination unit which divides the instructions into execution instruction sets based on predetermined simultaneous execution conditions, at least one of the execution instructions sets including a plurality of the instructions which are executable simultaneously;
an execution machine cycle correction unit which corrects the number of execution machine cycles of the instructions included in the at least one of the execution instruction sets to produce corrected information; and
a number-of-execution-machine-cycle measurement unit which outputs a simulation result including a processing time for execution of the analysis target program in response to the corrected information.

2. The simulation system according to claim 1, wherein
the simultaneous execution condition determination unit determines whether or not successive instructions in the analysis target program can be processed simultaneously in the plurality of pipelines and divides the instructions into the execution instruction sets such that at least one of the execution instruction sets includes the instructions which are determined to be simultaneously executable in the plurality of pipelines, and
the simultaneous execution conditions are defined on the basis of instructions that can be processed in each of the plurality of pipelines.

3. The simulation system according to claim 1, wherein the execution machine cycle correction unit sets the number of execution machine cycles of the instructions included in the at least one of the execution instruction sets to have the largest number among numbers of the execution machine cycles of the instructions.

4. The simulation system according to claim 1, further comprising:
a plurality of pipeline state storage sub units respectively corresponding to the plurality of pipelines, wherein
the simultaneous execution condition determination unit refers to the simultaneous execution conditions, and thereby divides the instructions into the execution instruction sets, and causes the pipeline state storage sub units to store all the execution instruction sets, and
the execution machine cycle correction unit refers to both the pipeline state storage sub units and a predetermined number of execution machine cycles, thereby searches for the largest number among the numbers of execution machine cycles of the instructions included in the at least one of the execution instruction sets, and then changes the numbers of the execution machine cycles of the instructions to the largest number.

5. The simulation system according to claim 4, wherein
in a case where at least one of the execution instruction sets stored in the pipelines state storage sub units includes an arithmetic execution instruction set for performing arithmetic operations using the same register, the simultaneous execution condition determination unit divides the arithmetic execution instruction set into a plurality of hazard execution instruction sets,
the plurality of hazard execution instruction sets are not executable simultaneously in the plurality of pipelines, and
the simultaneous execution condition determination unit causes the pipeline state storage sub units to store the hazard execution instruction sets as the execution instruction sets, in place of the arithmetic execution instruction set stored in the pipeline state storage sub units.

6. The simulation system according to claim 4, further comprising:
a use register information storage unit which includes, therein, an identifier for identifying an arithmetic instruction among the instructions and a register name for a register to be used when the arithmetic instruction is executed by the processor, wherein
the simultaneous execution condition determination unit refers to the pipeline state storage subunits and the use register information storage unit, and then divides an arithmetic execution instruction set for performing arithmetic operations using the same register, into a plurality of hazard execution instruction sets in a case where at least one of the execution instruction sets stored in the pipeline state storage sub units includes the arithmetic execution instruction set,
the plurality of hazard execution instruction sets are not executable simultaneously in the plurality of pipelines, and
the simultaneous execution condition determination unit causes the pipeline state condition subunits to store the hazard execution instruction sets as the execution instruction sets, in place of the arithmetic execution instruction set stored in the pipeline state storage sub units.

7. A simulation method of simulating an operation of a processor including a plurality of pipeline mechanisms, comprising:
executing each of instructions included in an analysis target program formed of an instruction set executable by the processor;
dividing the instructions into execution instruction sets based on predetermined simultaneous execution conditions, at least one of the execution instruction sets including a plurality of the instructions which are executable simultaneously;
correcting the number of execution machine cycles of the instructions included in the at least one of the execution instruction sets to produce corrected information; and
outputting a simulation result including a processing time for execution of the analysis target program in response to the corrected information.

8. The simulation method according to claim 7, wherein
in the dividing, whether or not successive instructions in the analysis target program can be processed simultaneously in the plurality of pipelines is determined and the instructions are divided into the execution instruction sets such that at least one of the execution instruction sets includes the instructions which are determined to be simultaneously executable in the plurality of pipelines, and
the predetermined simultaneous execution conditions are defined on the basis of instructions that can be processed in each of the plurality of pipelines.

9. The simulation method according to claim 7, wherein the correcting comprises:
setting the number of execution machine cycles of the instruction included in the at least one of the execution instruction sets to have the largest number among numbers of the execution machine cycles of the instructions.

10. The simulation method according to claim 7, wherein the correcting comprises:
searching the largest number among the numbers of the execution machine cycles of the instructions included in the at least one of the execution instruction sets; and
changing the numbers of the execution machine cycles of the instructions to the largest number.

11. The simulation method according to claim 7, wherein the dividing further comprises:
dividing an arithmetic execution instruction set into a plurality of hazard execution instruction sets in a case where at least one of the execution instruction sets includes the arithmetic execution instruction set for performing arithmetic operations using the same register, the plurality of hazard execution instruction sets indicating a combination of instructions which are not executable simultaneously in the plurality of pipelines; and
replacing the arithmetic execution instruction set by the hazard execution instruction sets as the execution instruction sets.

12. A computer program product embodied on a computer-readable medium and comprising code that, when executed, causes computer to perform a simulation of an operation of a processor including a plurality of pipeline mechanisms, the computer program comprising:
executing each of instructions included in an analysis target program formed of an instruction set executable by the processor;
dividing the instructions into execution instruction sets based on predetermined simultaneous execution conditions, at least one of the execution instruction sets including a plurality of the instructions which are executable simultaneously;
correcting the number of execution machine cycles of the instructions included in the at least one of the execution instruction sets to produce corrected information; and
outputting a simulation result including a processing time for execution of the analysis target program in response to the corrected information.

13. The computer program product according to claim 12, wherein
in the dividing, whether or not successive instructions in the analysis target program can be processed simultaneously in the plurality of pipelines is determined and the instructions are divided into the execution instruction sets such that at least one of the execution instruction sets includes the instructions which are determined to be simultaneously executable in the plurality of pipelines, and
the predetermined simultaneous execution conditions are defined on the basis of instructions that can be processed in each of the plurality of pipelines.

14. The computer program product according to claim 12, wherein the correcting comprises:
setting the number of execution machine cycles of the instructions included in the at least one of the execution instruction sets to have the largest number among numbers of the instructions.

15. The computer program product according to claim 12, wherein the correcting comprises:
searching the largest number among the numbers of the execution machine cycles of the instructions included in the at least one of the execution instruction sets; and
changing the numbers of the execution machine cycles of the instructions to the largest number.

16. The computer program product according to claim 12, wherein the determining further comprises:
dividing an arithmetic execution instruction set into a plurality of hazard execution instruction sets in a case where at least one of the execution instruction sets includes the arithmetic execution instruction set for performing arithmetic operations using the same register, the plurality of hazard execution instruction sets indicating a combination of instructions which are not executable simultaneously in the plurality of pipelines; and
replacing the arithmetic execution instruction set by the hazard execution instruction sets as the execution instruction sets.

17. A simulation method, comprising:
executing each of instructions included in an analysis target program;
dividing the instructions into a plurality of sets, at least one of the sets including a plurality of the instructions which are executable in parallel to each other;
correcting the number of execution machine cycles of the instructions included in the at least one of the sets to produce corrected information; and
outputting a simulation result including a processing time for execution of the analysis target program in response to the corrected information.
